(19) United States
(12) Patent Application Publication
(10) Pub. No.: US 2021/0155213 A1
(43) Pub. Date: May 27, 2021

(54) CONTROL UNIT ACTUATOR ASSEMBLY

(71) Applicant: Robert Bosch GmbH, Stuttgart (DE)

(72) Inventors: Stefan Hoess, Hessigheim (DE); Achim Pruksch, Neudenau (DE); Joerg Martin Schumacher, Stuttgart (DE)

(21) Appl. No.: 16/633,357

(22) PCT Filed: Jul. 19, 2018
(86) PCT No.: PCT/EP2018/069570

§ 371 Date: Jan. 23, 2020

(30) Foreign Application Priority Data
Jul. 25, 2017 (DE) 10 2017 212 708.2

(51) Int. Cl. B60T 8/36; B60T 17/02

(52) U.S. Cl. CPC B60T 8/368; B60T 13/686; B60T 17/02

(57) ABSTRACT

A control unit actuator assembly having a control unit and an actuator is provided with a sensor system which has a carrier body that is attachable to a component of the assembly in various angular positions.

### FIELD OF THE INVENTION

The present invention relates to a control unit actuator assembly, in particular for a brake system in a vehicle, having a control unit and an actuator, which are interconnected, as well as a sensor system that is configured in the assembly.

### BACKGROUND INFORMATION

ESP (electronic stability program) systems are known, which can be used to automatically intervene in the brake system of the vehicle to stabilize the same. The hardware of the ESP system includes a hydraulic unit and a control unit, which is connected to the housing of the hydraulic unit and, together therewith, forms a common assembly. Sensor information, which originates from external sensors, such as wheel-speed and steering angle sensors, are fed to the control unit. Moreover, the assembly is the carrier of a rotation-rate sensor and of a transversal-acceleration sensor for determining the actual state of the vehicle. They are located on a printed circuit board of the control unit of the assembly.

### SUMMARY OF THE INVENTION

The control unit actuator assembly according to the present invention may be used in vehicles, for example, in a brake system of the vehicle for adjusting the hydraulic pressure. The assembly includes a control unit and an actuator, which are interconnected and are installed together at the location provided therefor, in particular in the brake system of the vehicle. The control unit actuator assembly is an ESP assembly, for example, having a hydraulic unit and an associated control unit for controlling the hydraulic unit or what is generally referred to as an integrated power brake (IPB), whose actuator includes an electrohydraulic unit and a valve unit and is used to adjust the hydraulic pressure in the brake system in response to a braking request by the driver or a driver assistance system. The integrated power brake may include a brake-fluid reservoir for holding brake fluid.

Both in the case of the ESP assembly and the integrated power brake, the actuators are electrohydraulic, as an electric motor drives a hydraulic pump (ESP) or a hydraulic cylinder or plunger (IPB).

The control unit actuator assembly is provided with a sensor system that is part of the assembly and has a signal connection with the control unit. The sensor data recorded in the sensor system are transmitted to the control unit and further processed in the control unit, in particular to generate actuating signals for the actuator. Also possible in some instances is a signal transmission or current transmission from the control unit to the sensor system.

In a practical embodiment, the sensor system in the assembly is an inertial sensor system having a rotation-rate sensor and at least one acceleration sensor, which may be for measuring the transversal acceleration, also optionally for measuring the longitudinal acceleration. The rotation-rate sensor may be used to determine the current motion of the assembly about the vertical axis. Thus, when the assembly is installed in a vehicle, it is a question of determining the yaw motion with the aid of the rotation-rate sensor and of determining the lateral vehicle acceleration and, optionally, the longitudinal vehicle acceleration.

The sensor system has a carrier body in which at least one sensor of the sensor system is accommodated. In or on the carrier body, there is at least one signal transmission contact segment, via which signals are transmitted between the sensor system and the control unit. Relative to an axis of the carrier body, the signal transmission contact segment is arc-shaped, in particular circular.

At the same time, this axis of the carrier body forms a rotation axis thereof. The carrier body is attachable to a component of the assembly in various angular positions about the rotation axis.

In various installation positions of the control unit actuator assembly, this variant makes it possible to orient the sensor system to a coordinate system of the device or apparatus, which is integrated in the assembly. It is thus possible, for example, upon installation of the assembly in a brake system in a vehicle, to orient the sensor system to the coordinate system of the vehicle; it being possible to integrate the assembly in the vehicle, respectively in the brake system of the vehicle, in various installation positions. In particular, it is possible that the orientation be to the transverse axis of the vehicle, and that the assembly be installed in various angular positions relative to the transverse axis of the vehicle, and, at the same time, that it be ensured, by rotating the carrier body of the sensor system about the carrier-body rotation axis, which, in some instances, coincides with the transverse axis of the vehicle, that the sensor system be brought into a desired angular position relative to the coordinate system of the vehicle. Via the sensor system, this makes it possible to determine driving state variables in the vehicle coordinate system independently of or at least substantially independently of the angular installation position of the assembly in the vehicle. Sensor signal falsifications, which may arise in the case of a skewed installation situation of the sensor system in the vehicle, are hereby avoided.

Regardless of the active angular position of the sensor system in the assembly, a reliable signal transmission is possible between the sensor system and the control unit. The control unit is located in a fixed position on the actuator; the relative angular position between the control unit and the actuator is specification-dependent and generally not modifiable. To nevertheless ensure a reliable signal transmission in the case of a skewed installation situation of the assembly, on the one hand, and a compensation thereof by rotating the sensor system, on the other hand, the signal transmission contact segment is arc-shaped, in particular circular or part-circular. This makes it possible for a contact with the control unit to be made along the entire surface of the signal transmission contact segment. A mating contact, which is permanently connected to the control unit and leads to a printed circuit board therein, advantageously comes into touching contact with the signal transmission contact segment of the sensor system. The touching contact is possible between the mating contact and the signal transmission contact segment over the entire arc-shaped surface that extends around the rotation axis of the carrier body.

In accordance with an advantageous design, at least two signal transmission contact segments, which are positioned so as to be angularly offset from each other, are disposed on the sensor system. More than two signal transmission contact segments may be optionally provided, for example, four distributed over the periphery. If a plurality of signal transmission contact segments are provided, they each advantageously extend over the same segment angle. In an exemplary embodiment, the signal transmission contact segments extend over altogether 360° and thus along a circumferential, closed circle. An electrically non-conductive separator may be disposed between two adjacent signal transmission contact segments. Depending on the number of signal transmission contact segments, a different number of various sensor signals may be transmitted between the sensor system and the control unit.

In accordance with another advantageous specific embodiment, located on the carrier body is another centrally configured signal transmission contact segment, which is disposed along the rotation axis and via which a signal transmission between the sensor system and the control unit is likewise possible. Clustered around this central signal transmission contact segment are the arc-shaped or circular signal transmission contact segments. All of the signal transmission contact segments are electrically insulated from one another, for example, by electrically insulating separators.

Moreover, it is expedient that all of the signal transmission contact segments reside in a common plane of a contact surface. This plane may extend orthogonally to the rotation axis of the carrier body. In an alternative embodiment, the signal transmission contact segments reside in different planes of the contact surface.

In accordance with another advantageous specific embodiment, the carrier body is configured as a carrier sleeve; the rotation axis being formed by the longitudinal axis of the carrier sleeve. One or a plurality of sensors of the sensor system is/are located in the sleeve-shaped carrier body, in particular on a sensor-system printed circuit board, to which the signal transmission contact segments are electrically connected. The signal transmission contact segments are advantageously situated outside of the carrier body, in particular of the carrier sleeve, for example, upstream of the end face of the carrier sleeve.

In accordance with another expedient specific embodiment, the carrier body is rotatably mounted on the housing of the actuator. The rotatability is provided, for example, by the carrier body being inserted into a recess that is introduced into the housing of the actuator on the side facing the control unit. Upon joining of the control unit and the actuator, the signal transmission contact segments establish an electrical signal connection with the control unit, a possible skewed installation position of the assembly being compensated by a rotation of the carrier body. The carrier body of the sensor system may be screwed into the recess in the housing of the actuator or adjusted therein, for example.

The sensor system may be located outside of the housing of the control unit and, there, is in signal connection with the control unit. Variants are also possible where the at least one signal transmission contact segment projects into the housing of the control unit.

The present invention also relates to a control unit that is part of the control unit actuator assembly. The control unit includes a control unit housing and, accommodated therein, a printed circuit board, with which the sensor system is in signal connection.

Further advantages and useful embodiments are to be inferred from the further descriptions herein, the description of the figures, and the drawings.

Identical or corresponding components are provided with the same reference numerals in the figures.

### BRIEF DESCRIPTION OF THE DRAWINGS

FIG. 1 shows a perspective view of a control unit actuator assembly, which is configured as an integrated power brake having an electric motor as actuator, a control unit and a valve housing.

FIG. 2 shows a representation of a vehicle having the vehicle coordinate system, the control unit actuator assembly in accordance with FIG. 1 being installed in the brake system of the vehicle.

FIG. 3 shows the control unit actuator assembly from FIG. 1 in a side view, however, without a control unit, including a sensor system on the valve housing a carrier sleeve of the sensor system being mountable in various angular positions on the valve housing.

FIG. 4 is an illustration in accordance with FIG. 3, but in an angularly twisted position of the control unit actuator assembly.

FIG. 5 is a plan view of the sensor system having a plurality of signal transmission contact segments tor transmitting signals between the sensor system and the control unit.

FIG. 6 shows a sectional view longitudinally through the carrier sleeve of the sensor system.

### DETAILED DESCRIPTION

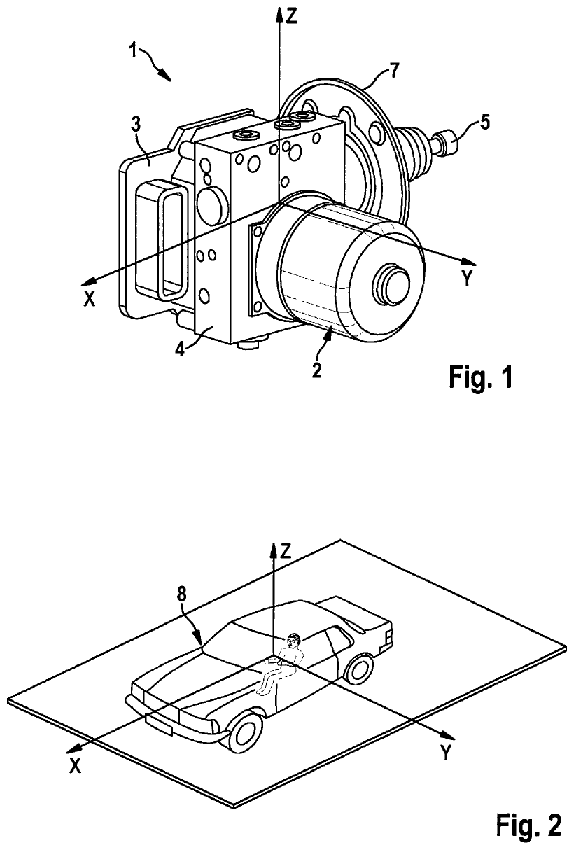

The control unit actuator assembly 1 illustrated in FIGS. 1, 3 and 4 is an integrated power brake (IPB) that may be installed in a hydraulic brake system in a vehicle. With the aid of the control unit actuator assembly, it is possible to implement both a brake boost, as well as a vehicle stabilization by modulating the hydraulic brake pressure on the wheel brake units of the vehicle.

Assembly 1 includes an actuator 2, which is configured as an electrohydraulic unit having an electric motor, as well as a control unit 3, which is held on a housing 4 of actuator 2. Housing 4 includes a valve housing.

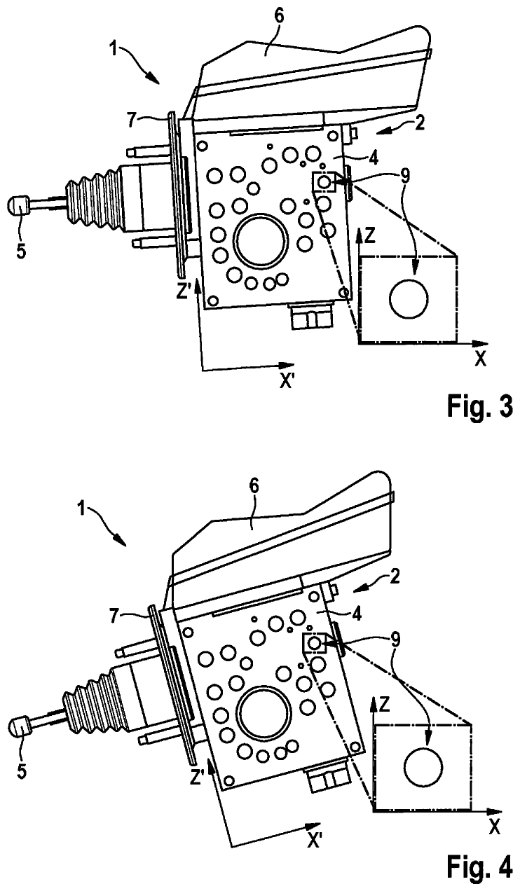

Moreover, part of assembly 1 is a transmission element 5, which is coupled to the brake pedal in the vehicle and translates a brake-pedal movement into a positioning movement of transmission element 5, whereupon electrohydraulic unit 2 is actuated, and the hydraulic brake pressure in the brake system is modulated. Moreover, part of assembly 1 is a brake fluid reservoir 6, which is attached to housing 4 and holds brake fluid (FIGS. 3, 4). A mounting disk 7 located on housing 4 is used to attach assembly 1 in the brake system.

FIG. 2 depicts a vehicle 8, whose coordinate system includes vehicle longitudinal axis x, vehicle transversal axis y, and vehicle vertical axis z. Vehicle-based coordinate system x, y, z is also entered in FIG. 1 in assembly 1 to illustrate the installation position thereof in vehicle 8. Rod-shaped transmission element 5 extends at least approximately parallel to longitudinal axis x of the vehicle; the longitudinal axis of the electric motor extends at least approximately parallel to transverse axis y of the vehicle.

FIGS. 3 and 4 show assembly 1 without control unit 3. Located on that side of housing 4, which generally receives control unit 3, is a sensor system 9, which, in particular is an inertial sensor system having a rotation-rate sensor and one or a plurality of acceleration sensors. As accelerations, at least the transversal acceleration, optionally also the longitudinal acceleration may be ascertained by sensor system 9. Sensor system 9 is attached to housing 4 of actuator 2 and, for signal transmission, is in contact with control unit 3.

As may be inferred from FIG. 6, in particular, sensor system 9 has a cylindrical carrier sleeve 10 as a carrier body, for example, which houses a sensor-system printed circuit board 12 having sensors 13 and 14. Sensors 13 and 14 are the sensors of an inertial sensor system; other sensors, such as a pressure sensor, for example, may also be optionally included on sensor-system printed circuit board 12. The longitudinal axis of carrier sleeve 10 is denoted by reference numeral 11.

Carrier sleeve 10 of sensor system 9 is mounted on housing 4 in such a way that longitudinal axis 11 thereof is disposed approximately orthogonally to the straight, plane outer surface of housing 4. At the same time, carrier sleeve 10 is rotatably accommodated on housing 4 about longitudinal axis 11, so that longitudinal axis 11 simultaneously forms a rotation axis of carrier sleeve 10 and thus of sensor system 9.

In the exemplary embodiment in accordance with FIGS. 3 and 4, rotation axis or longitudinal axis 11 of sensor system 9 coincides with vehicle transversal axis y. The rotatability of sensor system 9 on housing 4 makes it possible to orient sensor system 9 with x and z axes thereof coinciding exactly with vehicle longitudinal axis x and vehicle vertical axis z (FIG. 2), regardless of the installation position of assembly 1, whose coordinate system is marked in FIGS. 3 and 4 with longitudinal axis x′ and vertical axis z′. In accordance with FIG. 3, the coordinate systems of sensor system 9 and of assembly 1 diverge slightly in response to a rotation about the transverse axis; the angle of twist about the transverse axis is on the order of maximally 5°. In FIG. 4, the coordinate systems of sensor system 9 and of assembly 1 diverge more; the angle of twist about the transverse axis is on the order of up to 20°. This relative rotation between assembly 1 and sensor system 9 makes it possible for sensor system 9 to be oriented to the coordinate system of vehicle 8 regardless of the installation position of assembly 1, whereby an error in the sensor signals of sensor system 9 is avoided.

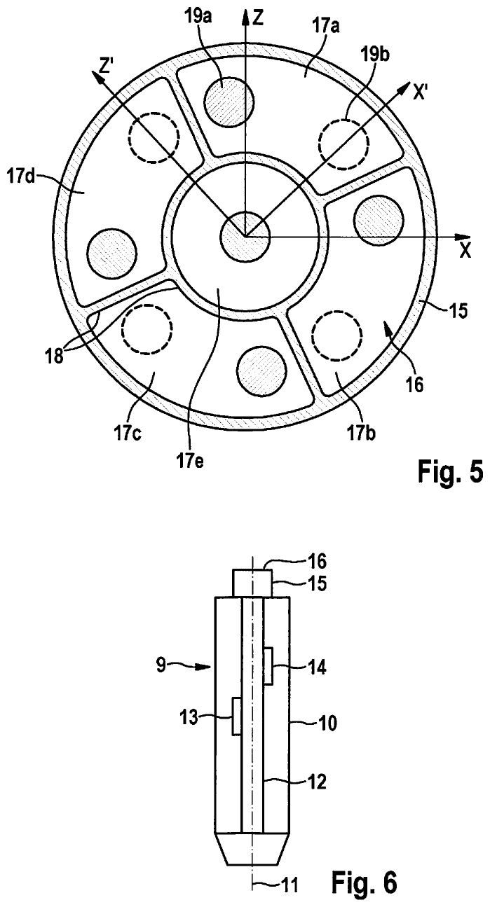

As may be inferred from FIG. 5 in conjunction with FIG. 6, located adjacently to top end face of carrier sleeve 10 is a contact portion 15, whose free end face forms a contact surface 16, via which signals are transmitted between sensor system 9 and control unit 3. Plane contact surface 16 of contact portion 15 is subdivided into a plurality of signal transmission contact segments 17a through 17e. Each signal transmission contact segment 17 is configured to be electrically conductive, the various signal transmission contact segments being electrically separated from one another by separators 18. In the mounted state, signal transmission contact segments 17 of mating contacts are contacted by mating contacts on control unit 3 to establish a signal transmission path between sensor system. 9 and control unit 3. Each signal transmission contact segment 17a through 17e is advantageously connected to the control unit.

In each case, outer signal transmission contact segments 17a through 17d are disposed in a circle and extend over alp angular segment of 90°. Inner, central signal transmission contact segment 17e is intersected by the rotation axis and is enclosed by outer, circular contact segments 17a through 17d.

In outer signal transmission contact segments 17a through 17d, two contact points 19a, 19b are show in each particular case, of which first contact point 19a is sketched in hatched shading and second contact point 19b with a dashed border. Contact points 19a, 19b represent examples of the contacting by the mating contacts on the control unit side. Contact points 19a and 19b illustrate that a signal transmission to the control unit is possible within the entire surface of a signal transmission contact segment. Since each outer signal transmission contact segment 17a through 17d extends over an angular segment of 90°, carrier sleeve 10 of sensor system 9 may be rotated about longitudinal or rotation axis 11 by approximately 90°; within this angle of twist, the contact of relevant signal transmission contact segment 17a through 17d with the mating contact on the control unit being retained. Thus, the angle in the exemplary embodiment in accordance with FIG. 5, by which sensor system 9 may be rotated about the longitudinal axis thereof on the housing, is approximately 90°.

1-12. (canceled)

13. A control unit actuator assembly, for a brake system in a vehicle, comprising:
a control unit;
an actuator interconnected with the control unit; and
a sensor system, wherein the sensor system has at least one signal transmission contact segment in or on a carrier body of the sensor system for providing sensor signal transmission to the control unit, and wherein the signal transmission contact segment is arc-shaped relative to an axis of the carrier body, the axis of the carrier body forming a rotation axis, and the carrier body being attachable to a component of the assembly in different angular positions about the rotation axis.

14. The assembly of claim 13, wherein at least two signal transmission contact segments are disposed so as to be angularly offset from each other about the rotation axis of the carrier body of the sensor system.

15. The assembly of claim 14, wherein the at least two signal transmission contact segments extend over altogether 360°.

16. The assembly of claim 13, wherein a central signal transmission contact segment, disposed along the rotation axis, is located in or on the carrier body.

17. The assembly of claim 13, wherein all of the signal transmission contact segments are located in a common plane.

18. The assembly of claim 13, wherein the carrier body of the sensor system is formed as a carrier sleeve, and the rotation axis is formed by the longitudinal axis of the carrier sleeve.

19. The assembly of claim 13, wherein the carrier body of the sensor system is mountable on the housing of the actuator in different angular positions.

20. The assembly of claim 19, wherein the carrier body of the sensor system is rotatably inserted into a recess in the housing of the actuator.

21. The assembly of claim 13, wherein the assembly is in a brake system in a vehicle, and wherein the rotation axis of the carrier body of the sensor system extends parallel to the transverse axis of the vehicle.

22. The assembly of claim 13, wherein the assembly is in a brake system in a vehicle, and wherein a brake fluid reservoir is on the housing of the actuator.

23. The assembly of claim 13, wherein the actuator includes an electrohydraulic actuator.

24. The assembly of claim 13, wherein at least two signal transmission contact segments are disposed so as to be angularly offset from each other about the rotation axis of the carrier body of the sensor system, and wherein a central signal transmission contact segment, disposed along the rotation axis, is located in or on the carrier body.
